(19) United States
(12) Patent Application Publication
(10) Pub. No.: US 2006/0205372 A1
(43) Pub. Date: Sep. 14, 2006

(54) Agc circuit arrangement for a tuner

(76) Inventors: Aaron Reel Bouillet, Noblesville, IN (US); Matthew Thomas Mayer, Indianapolis, IN (US)

Correspondence Address: THOMSON LICENSING INC., PATENT OPERATIONS, PO BOX 5312, PRINCETON, NJ, 08543-5312, US

(21) Appl. No.: 10/542,466

(22) PCT Filed: Jan. 20, 2004
(86) PCT No.: PCT/US04/01582

§ 371 Date: Jul. 15, 2005

Related U.S. Application Data
(60) Provisional application No. 60/440,720, filed on Jan. 17, 2003.

(51) Int. Cl. H04B 7/00; H04B 1/06

(52) U.S. Cl. 455/234.1

(57) ABSTRACT

A method and apparatus for generating the adaptive gain control signals in a communications receiver is disclosed. The present invention can be used with existing two stage gain architectures, and overcomes many undesirable characteristics of the previous mechanism. An apparatus is presented wherein each of a plurality of RF AGC gain controllable amplifiers are individually controlled by individual AGC control signals generated by an AGC controller so that the level of the output signal from each of the RF AGC gain controllable amplifiers is individually optimized for tuner performance.

This application claims the benefit of U.S. Provisional Application Ser. No. 60/440,720, filed Jan. 17, 2003, and entitled “AGC CONTROLLER”, which is incorporated herein by reference in its entirety.

### FIELD OF THE INVENTION

The present invention concerns an automatic gain control (AGC) arrangement useful in a tuner. Specifically the present application discloses a method and mechanism for separating the IF and RF gain control signals from a tuner control means and generating adaptive gain control signals for use in a communications receiver.

### BACKGROUND OF THE INVENTION

Present day tuners do not work sufficiently well for processing digital signals received using various transmission systems. Both the RF and IF characteristics of the receivers need improvement since a digital signal occupies the entire spectrum of a channel, and delay and frequency response errors have a more severe effect on digital signals than on analog signals. Moreover, since the transmitted power of digital signals is considerably less than the transmitted power for analog transmissions, acceptable reception of the desired signal can be more difficult in the presence of strong adjacent channel signals. Further, the signal conditions in the fringe area of over-the-air transmissions are also a problem. For fringe areas, a few tenths of a dB loss of signal-to-noise ratio (SNR) or an increase of intermodulation distortion, can make the signal recovery difficult, if not impossible.

Conventional automatic gain control AGC systems in TV receivers typically are responsive to the level of the demodulated video signal. After comparison of the demodulated video signal with a reference, error voltages are generated to control the gain of the IF amplifier and RF stage of the tuner. To obtain a good SNR over a wide range of input levels, it is a common practice to delay the application of AGC to the tuner until relatively high signal levels are encountered. This works well in the absence of strong adjacent signals. However, if the signal level is low in the presence of strong adjacent signals, cross modulation with the strong adjacent signals could occur in the mixer and the bit error rate (BER) of the demodulated television information would increase.

The IF control is typically calculated digitally as the difference between the input RMS signal power and the predetermined reference. This control is then converted to an analog voltage which drives the analog IF amplifier. Typically, additional circuitry generates the analog RF amplifier control signal by acting on the analog IF control. However, since the RF control is derived from difference between the IF control and the delay point, the IF control cannot be held at the optimum operating point over most of the RF control range. It is undesirable that since the RF gain constant must be very large in order to keep the IF control voltage deviation from optimum minimized, stability problems can result because the detector-to-RF gain transfer typically will have a very large gain.

It is desirable to develop a method or mechanism to independantly control the RF and IF to achieve an optimal IF gain independent of the RF gain operating point. Increased flexibility over the IF and RF gain allows for faster RF signal tracking and therefore greater bandwidth for signal reception.

### SUMMARY OF THE INVENTION

In accordance with an aspect of the present invention, a method and apparatus for comprising an input receiving a first signal, a first signal path for integrating the difference between the first signal and a first reference level to produce a first control signal, and a second signal path for integrating the difference between the first control signal and a second reference level to produce a second control signal is disclosed

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram showing an RF section, an IF section and an AGC section of a receiver according to an exemplary embodiment of the present invention.

FIG. 2 is a block diagram showing an AGC generator according to the prior art.

FIG. 3 is a block diagram of an AGC generator according to an exemplary embodiment of the present invention.

### DETAILED DESCRIPTION OF THE PREFERRED EMBODIMENT

The exemplifications set out herein illustrate preferred embodiments of the invention, and such exemplifications are not to be construed as limiting the scope of the invention in any manner.

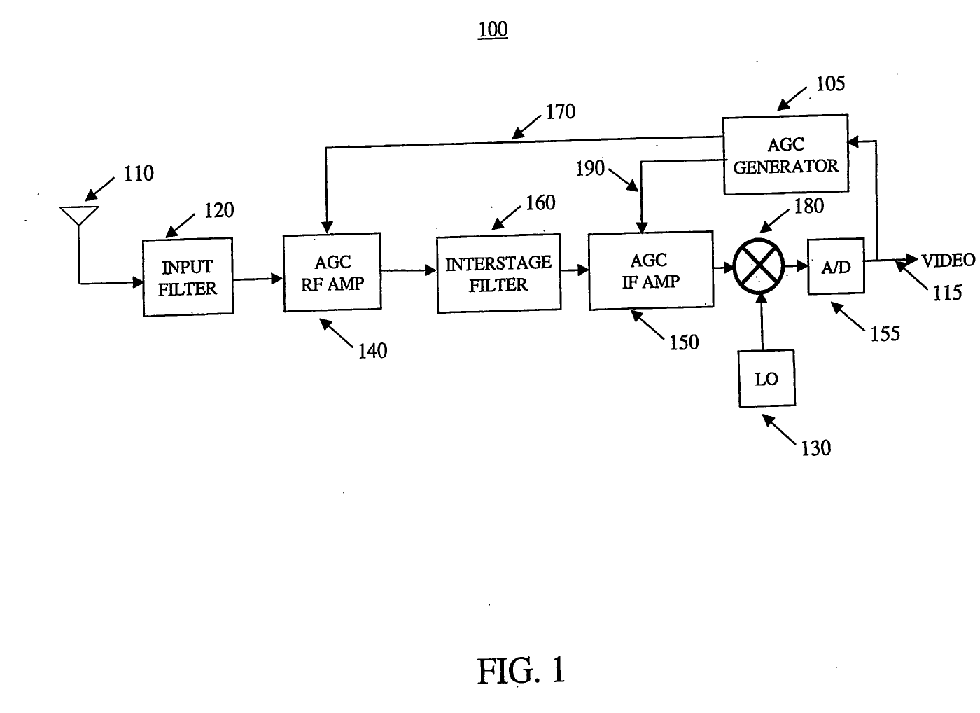

Referring to FIG. 1, a block diagram of an exemplary embodiment of television signal tuning apparatus is shown. FIG. 1 shows an RF, IF and AGC circuit arrangement wherein a signal source is coupled to input 110 and filtered by input filter 120. The signal from input filter 120 is coupled to amplifier 140, the gain of which is AGC controllable. The amplified signal from amplifier 140 is coupled to an interstage filter 160 and to mixer 180 where it is mixed with the signal generated by local oscillator 130 for producing the IF signal at lead 180. The IF signal is processed and amplified by IF section 150 which includes a gain controllable AGC amplifier and a video detector. A detected video output signal at lead 115 is coupled to AGC generator 105 to provide a responsive AGC control signal.

According to the exemplary embodiment of the present invention, a control signal is coupled to the IF section at lead 190 to adjust the gain of the IF section to keep the signal at lead 115 at a reasonably constant level for variations of source signal level at RF input terminal 110. If the level of signal at terminal 1 10 is very high, an AGC control signal is coupled via lead 170 to RF AGC gain controllable amplifier 140. This AGC control signal is derived according to the present invention and automatically adjusts to the point at which the IF AGC control signal equals the predetermined AGC Delay level, which is considered to be the optimum operating point for this signal. In such a case where the RF amplifier reaches either its maximum or minimum gain limit, the present invention allows the IF amplifier, via control signal 190, to move away from the AGC Delay point in order that the signal at the input to mixer 180 maintains its desired level. This control mechanism acts to maintain a good SNR.

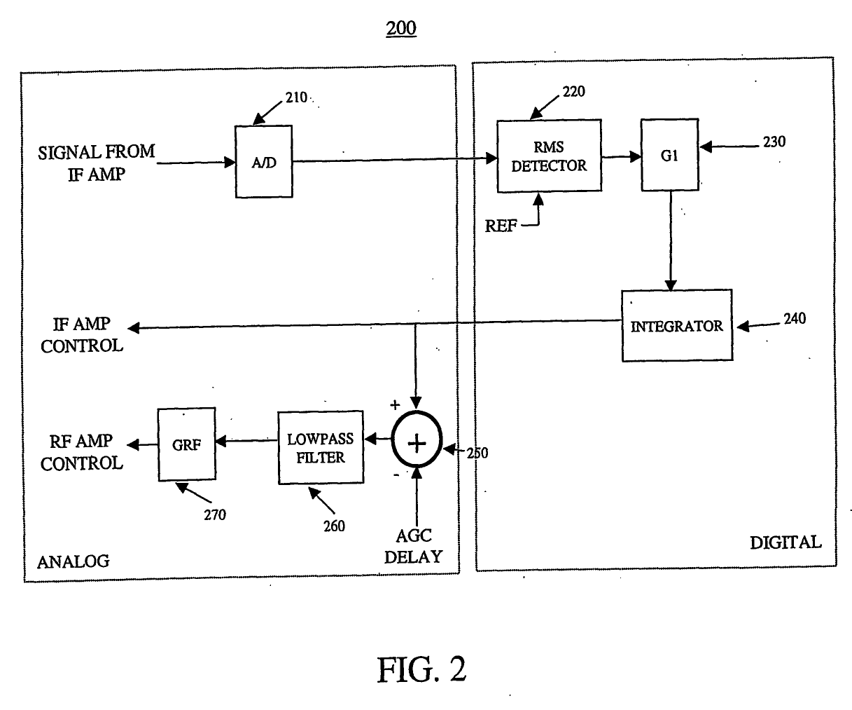

FIG. 2 shows a circuit arrangement, is a block diagram showing an AGC generator operating according to a convention method wherein the RF AGC is generating according to the following equation.
RF=G_{RF}(IF−DELAY)
Where IF is the IF-stage control signal, RF is the RF stage control signal, G_{RF} is a gain constant, and DELAY is the optimum IF control signal operating point when the RF stage is in gain reduction.

In the circuit in shown in FIG. 2, the signal from the AGC IF amplifier (150 of FIG. 1) is sampled by an analog to digital converter (210). The RMS value of this digital signal is then calculated by the RMS detector 220 and then compared to a predetermined reference level REF. The RMS detector 220 then outputs a value representing the difference between the reference value and the signal RMS value. A predetermined digital gain is then applied to this signal at G1 230. The signal is then passed through a digital integrator 240 to produce a digital representation of the IF AMP control signal. Once the signal is converted back to the analog domain, a portion of the signal is split from the IF AMP control and a summer 250 is used to determine the difference between the IF AMP control and the AGC DELAY point. The summer 250 outputs an analog signal representing the difference between the IF AMP CONTROL and the AGC DELAY. This signal is passed through a lowpass fiter 260 and is amplified by a predetermined fixed amount by GRF 270 of produce the RF AMP control signal.

In the conventional system, since the RF control is derived from the difference of the IF control from the delay point, the IF control cannot be held at the optimum operating point over most of the RF control range. Another drawback to this method is that the GRF constant must be very large in order to keep the IF control voltage deviation from optimum minimized. This causes stability problems because the detector-to-RF gain transfer typically will have very large gain.

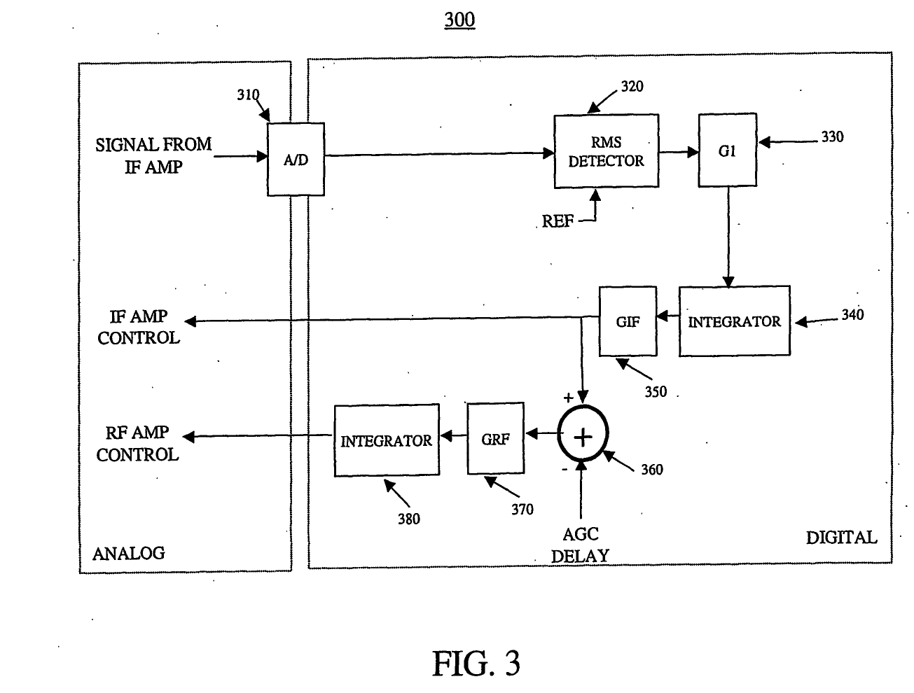

FIG. 3 shows an exemplary embodiment of the present invention which is based on having separate controls emanating from the digital circuitry for RF and IF amplifier control. The IF control signal is generated as before by subtracting an RMS measurement of the incoming signal from a predetermined reference. Unlike conventional implementations which operated according to equation 1.1, the RF control signal is generated according to equation 1.2 below.
RF=G_{RF}∫(IF−DELAY)dt

A block diagram of an exemplary embodiment of the present invention is described in FIG. 3, where the signal from the AGC IF amplifier (150 of FIG. 1) is sampled by an analog to digital converter (310). The RMS value of this digital signal is then calculated by the RMS detector 320 and then compared to a predetermined reference level REF. The RMS detector 320 then outputs a value representing the difference between the reference value and the signal RMS value. A predetermined digital gain is then applied to this signal at G1 330. The signal is then passed through a digital integrator 340 and then another predetermined digital gain is applied to this signal at GIF 350 to produce a digital representation of the IF AMP control signal. A digital value representing the ideal AGC DELAY point is subtracted from the digital representation of the IF AMP control signal by a digital summer 360. A predetermined digital gain is then applied to this signal at GRF 370. The signal is then passed through a digital integrator 380 to produce a digital representation of the RF amplifier control signal. This signal is converted into the analog domain and is applied to the AGC RF AMP (140 of FIG. 1)

It is the integrator 380 in the RF control path that yields the following desirable features such as, since the IF control is allowed to operate at its optimal point across the entire input signal range for which the RF stage is in gain reduction (at less than max gain). The detector-to-RF control bandwidth is subject to more control because of the introduction of the G_{rf} parameter. This leads to a more stable loop dynamic that can track input signal gain variation at a higher rate than the system shown in FIG. 2.

It should be noted that this arrangement is also applicable to standard analog received signals. The effect on the change of SNR for standard analog reception may be of little importance. However, even a slight decrease in SNR can have a detrimental effect for digital signals received at or close to a threshold level. For such a situation, the value of the AGC control signal coupled to the first AGC stage can be chosen so that the gain of the AGC stage is not reduced.

1. An apparatus comprising:
an input receiving a first signal;
a first signal path for integrating the difference between the first signal and a first reference level to produce a first control signal; and
a second signal path for integrating the difference between the first control signal and a second reference level to produce a second control signal.

2. The apparatus of claim 1 wherein the second reference level is an AGC delay point.

3. The apparatus of claim 1 wherein the first signal is an intermediate frequency signal from a tuner.

4. The apparatus of claim 1 wherein the first control signal and the second control signal control a first gain controllable amplifier and a second gain controllable amplifier in a tuner.

5. The apparatus of claim 1 wherein the integrating the difference between the first signal and a first reference level to produce a first control signal and the integrating the difference between the first control signal and a second reference level to produce a second control signal are performed by software.

6. The apparatus of claim 1 wherein the integrating the difference between the first signal and a first reference level to produce a first control signal and the integrating the difference between the first control signal and a second reference level to produce a second control signal are performed by hardware.

7. The apparatus of claim 1 wherein the integrating the difference between the first signal and a first reference level to produce a first control signal and the integrating the difference between the first control signal and a second reference level to produce a second control signal are performed internal to an integrated circuit.

8. A method comprising to steps of:
determining a first control value by integrating the difference between a signal level and a first reference level; and
determining a second control value by integrating the difference between the first control signal and a second reference level.

9. The method of claim 8 wherein the second reference level is an AGC delay point.

10. The method of claim 8 wherein the signal level is the RMS value of an input signal.

11. The method of claim 8 wherein the integrating the difference between the signal level and a first reference level and the integrating the difference between the first control signal and a second reference level are performed by hardware implemented in a digital integrated circuit.

12. The method of claim 8 wherein the integrating the difference between the signal level and a first reference level and the integrating the difference between the first control signal and a second reference level are performed by software.

13. The method of claim 8 wherein the first control value and the second control value control a first gain controllable amplifier and a second gain controllable amplifier in a tuner.

14. A gain control method comprising to steps of: converting an analog signal to a digital signal;
integrating the difference between a predetermined characteristic of said digital signal and a first reference level to produce a first control signal; and
integrating the difference between a predetermined characteristic of said first control signal and a second reference level to produce a second control signal.

15. The gain control method of claim 14 wherein the second reference level is an AGC delay point.

16. The gain control method of claim 14 wherein the predetermined characteristic of the digital signal is the RMS value.

17. The gain control method of claim 14 wherein the method is performed by hardware implemented in a digital integrated circuit.

18. The gain control method of claim 14 wherein the method is performed by software.

19. The gain control method of claim 14 wherein the first control signal and the second control value control a first gain controllable amplifier and a second gain controllable amplifier in a tuner.
